(19) United States
(12) Patent Application Publication
(10) Pub. No.: US 2024/0351682 A1
(43) Pub. Date: Oct. 24, 2024

(54) Electric Auxiliary Power Unit Based Electric Taxi System for Aircraft

(71) Applicant: Textron Aviation Inc., Wichita, KS (US)

(72) Inventor: Kyle Dietz Tidball, Wichita, KS (US)

(21) Appl. No.: 18/639,923

(22) Filed: Apr. 18, 2024

Related U.S. Application Data
(60) Provisional application No. 63/497,115, filed on Apr. 19, 2023.

(51) Int. Cl. B64C 25/32; B60L 7/08; B60L 7/18; B60L 7/22; B60T 8/17; B64C 25/42

(52) U.S. Cl. CPC B64C 25/405; B60L 7/08; B60L 7/18; B60L 7/22; B60T 8/1703; B64C 25/42; B60T 2270/60

(57) ABSTRACT

When grounded, aircraft may taxi using thrust from the main aircraft engines, which can waste fuel and is often inefficient. This disclosure outlines an electric aircraft taxi system, or eTaxi system, that can operate without continuous power from the aircraft engines, allowing the engines to be turned off during taxi to save fuel. An electric auxiliary power unit, or eAPU, is equipped on the aircraft and powers electric motor-generators that can both drive landing gear wheels and regenerate power from the wheels during regenerative braking. When the eTaxi system is on, a drive controller and a taxi controller gather inputs from the aircraft controls and converts them into commands sent to the electric motor-generators, brakes, and steering devices.

### CROSS-REFERENCE TO RELATED APPLICATIONS

This application claims the benefit of priority of U.S. Provisional Patent Application No. 63/497,115, entitled Electric Auxiliary Power Unit Based Electric Taxi System for Aircraft, filed Apr. 19, 2023, the disclosure of which is herein incorporated by reference in its entirety.

### BACKGROUND

### 1. Field

The disclosed embodiments relate generally to the field of electric propulsion. More specifically, the disclosed embodiments related to aircraft propulsion, braking, and steering during ground maneuvers utilizing electrically driven wheels and a battery electric auxiliary power unit (eAPU).

### 2. Related Art

Aircraft ground maneuvers, or taxiing, have traditionally been performed using the aircraft's main propulsion system. By their nature, turbofan/jet engines are less efficient at low altitudes (on the ground) than they are at higher altitudes where they are designed for nominal performance. Due to these inefficiencies, the fuel consumption rate of aircraft during taxiing is high. Therefore, it is desirable to be able to taxi an aircraft with the main engines off by driving the main landing gear wheels with electric motors.

Multiple solutions have been provided to taxi an aircraft by means of electrically driven main landing gear wheels. U.S. Patent Publication No. 2021/0192964 to Van Deventer et al. discloses an aircraft taxiing system. In some examples, the energy storage locations include a gas turbine auxiliary power unit and battery, which could provide electric energy for powering a number of electric motors in taxiing. U.S. Patent Publication No. 2019/0375512 to Ribeiro et al. discloses hybrid electric taxi system (HETS) or full electric taxi system (FETS). During ground operations the core engine fuel supply is turned off and the engines are driven on electrical power only. U.S. Pat. No. 8,093,747 to Pearson et al. discloses an electrical power system architecture. In some examples, the electrical power system architecture may use a gas turbine auxiliary power unit (APU) as an electrical power source during taxi to drive electric motors in the main gear wheels. U.S. Pat. No. 8,727,270 to Burns et al. discloses a system for taxiing an aircraft without starting one or more main aircraft propulsion engines. In some examples, a hybrid gas turbine APU is configured to supply rotational power to both HP spool and LP spool to provide sufficient thrust to taxi aircraft without starting one or more engines. U.S. Pat. No. 9,849,849 to Vieillard et al. discloses a device for supplying electrical power to an aircraft on the ground. U.S. Pat. No. 9,567,100 to Jackson et al. discloses an electric taxi predictive performance system. In some examples, the electric taxi (eTaxi) system provides ground movement using a gas turbine auxiliary power unit generator (APUG) powering electric drive motor(s). U.S. Pat. No. 11,149,649 to Terwilliger et al. discloses a hybrid gas turbine engine system of a hybrid electric aircraft. The hybrid gas turbine engine system includes an electric motor operable to perform an electric taxiing of the hybrid electric aircraft.

Non-patent article “eTaxi Taxiing aircraft with engines stopped” to Nicolas discloses eTaxi systems in which one could taxi aircraft with engines stopped. Pages 6-7 of the article disclose a full eTaxi solution where one could get a full eTaxi performance with all engines stopped in every condition (e.g., taking in consideration the aircraft weight) with a modified gas turbine APU. FIG. 6 provides examples of control diagrams for implementing the disclosed eTaxi systems. Non-patent article “More Electric Aircraft: Review, Challenges, and Opportunities for Commercial Transport Aircraft” to Sarlioglu et al. discloses review, challenges, and opportunities for commercial transport aircraft based on the idea of a more electric aircraft. FIG. 3(b) discloses a diagram of the main engine start system with electric APUs, consisting of a gas turbine engine driving an electrical generator to produce only electrical power. FIG. 8 discloses an electric taxi architecture with fuel cell electric power generation system and battery pack as additional energy storage implementations.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In embodiments of the present disclosure, an eAPU-based aircraft taxi control system includes: an electric auxiliary power unit configured to provide electrical power; a drive controller configured to control a main gear electric motor-generator; an electric brake actuator controller configured for providing braking; and a taxi controller operatively coupled to the electric auxiliary power unit, the drive controller, the electric brake actuator controller and preexisting aircraft controls, wherein the taxi controller is configured to provide steering and drive control for taxiing the aircraft based on inputs received from the preexisting aircraft controls without receiving power from an aircraft engine.

In embodiments of the present disclosure, an aircraft taxi system includes: an electric power source configured to supply stored power installed on an aircraft configured to power aircraft and taxi system components; a plurality of main gear wheels each including: an electric motor-generator configured to drive a main gear wheel when powered by the electric power source and configured to provide regenerative braking; an electro-mechanical brake configured to provide a braking force on the main gear wheel; and a brake resistor configured to provide regenerative braking by converting electricity into heat; and a taxi controller configured to control the plurality of main gear wheels for performing forward and reverse driving, braking, and steering.

In embodiments of the present disclosure, a method for electric aircraft taxiing includes: providing electric power from an auxiliary power source configured onboard an aircraft, wherein the auxiliary power source provides electric power independent of aircraft engine power; and integrating a taxi controller with preexisting cockpit controls such that the cockpit controls are configured to control the aircraft via the taxi controller for performing the electric taxiing steps of; driving at least one main landing gear wheel powered by the electric power source for driving the aircraft; steering a nosewheel for steering the aircraft; and braking the at least one main landing gear wheel for braking the aircraft.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a schematic representation of an eTaxi system for aircraft using an eAPU in an embodiment;

FIG. 2 is a schematic representation of an embodiment computing device as may be used to carry out functions of the aircraft eTaxi system discussed in FIGS. 1 and 3;

FIG. 3 is a schematic representation of components of eTaxi system 10 that may execute software and commands using the computing device of FIG. 2;

FIG. 4 is a diagram of a landing gear outfitted with a main-gear electric motor-generator configured to drive an axle directly on a main gear landing gear; and

FIG. 5 is a diagram of a landing gear outfitted with a main-gear electric motor-generator configured to drive an axle via a driveshaft on a main gear landing gear.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments, but is not necessarily included. Thus, the technology can include a variety of combinations and/or integrations of the embodiments described herein.

Aircraft taxiing is typically performed using thrust from the main aircraft engines to provide motion on wheels of the aircraft landing gear. This process can be inefficient and may waste fuel that could be burned more efficiently during flight.

Embodiments disclosed herein provide for an electric auxiliary-power-unit (eAPU)-based electric taxi system for aircraft. The eAPU-based eTaxi system provides an all-electric large, high energy-density battery that may replace a traditional gas turbine auxiliary power unit (APU) installed in an aircraft. The eAPU provides electrical power for the aircraft systems while the main engine generators are offline and enables crew to prepare the aircraft for flight without aircraft engine power and therefore without consuming any fuel. In an embodiment, the eAPU provides electrical power to a system that controls motor-generators and brakes housed within the main landing gear wheels, which allows the crew to taxi the aircraft on electrical power only.

There are several potential advantages provided by an eAPU-based eTaxi system for aircraft:
The aircraft could save fuel by allowing the crew to start the engines only for the minimum time required before takeoff and stop the engines as soon as they have moved clear of the runway after landing, thus reducing engine run time and fuel consumption;
By reducing the run time of the engines, there is a potential reduction of wear on the engines, which are generally the single most expensive maintenance item on the aircraft;
In addition to conventional braking, the system would allow the use of regenerative braking, converting the kinetic energy of the aircraft into electrical energy to recharge the eAPU, reducing the turn-around time of the aircraft and reducing the maintenance costs associated with replacing traditional mechanical brakes;
By converting to a brake-by-wire system, a hydraulic braking system can be eliminated from an aircraft, reducing aircraft weight and the number of flammable fluid zones in the aircraft;
The system could be used to provide autonomous braking (or “auto-braking”), allowing the aircraft to reduce speed autonomously during the roll-out after landing so as to exit the runway at a pre-selected taxiway. By using the calculated ground speed of the aircraft at the touchdown point, the landing configuration of the aircraft (e.g., flaps, spoilers, thrust reverse) and the condition of the runway surface provided by the crew, the system could calculate the amount of braking force necessary for constant deceleration to arrive at the crew-selected taxiway at a safe runway exit speed. Said braking force can then be automatically applied to the aircraft via regenerative braking, charging the eAPU, or putting energy into the braking resistor, supplemented by the mechanical brakes of the aircraft;
The eTaxi system for aircraft using an eAPU could provide the ability to decrease take-off distances by electrically driving the main landing gear wheels via the electric motor-generators during a Takeoff/Go-around thrust (TO/GA) takeoff. This would allow the aircraft to accelerate more quickly than relying on only the thrust from the engines, reducing the takeoff distance;
The system could be used to drive the wheels on the main landing gear during final approach to landing in order to match the ground speed of the aircraft. By using the calculated ground speed of the aircraft during final approach, the landing configuration of the aircraft (e.g., flaps, spoilers, thrust reverse) and the condition of the runway surface provided by the crew, the system could calculate the speed at which to spin the main gear wheels to match ground speed at touchdown. This may reduce wear on the tires, reducing the need for replacement. This example could also be used in an off-airport landing package for special-missions aircraft that would be landing on unimproved (gravel or dirt) runway surfaces. This provides a safety feature and assists the crew in maintaining control of the aircraft after touchdown;
In some embodiments, the system could decrease the turning radius of an aircraft by electrically driving one main gear wheel forward, and the other main gear wheel in reverse, improving ground maneuverability in confined spaces: and,
The system may provide for the ability to vary the gain of the nosewheel steering systems based on the state of the motor-generator and drive speed improving controllability of the aircraft during ground maneuvers.

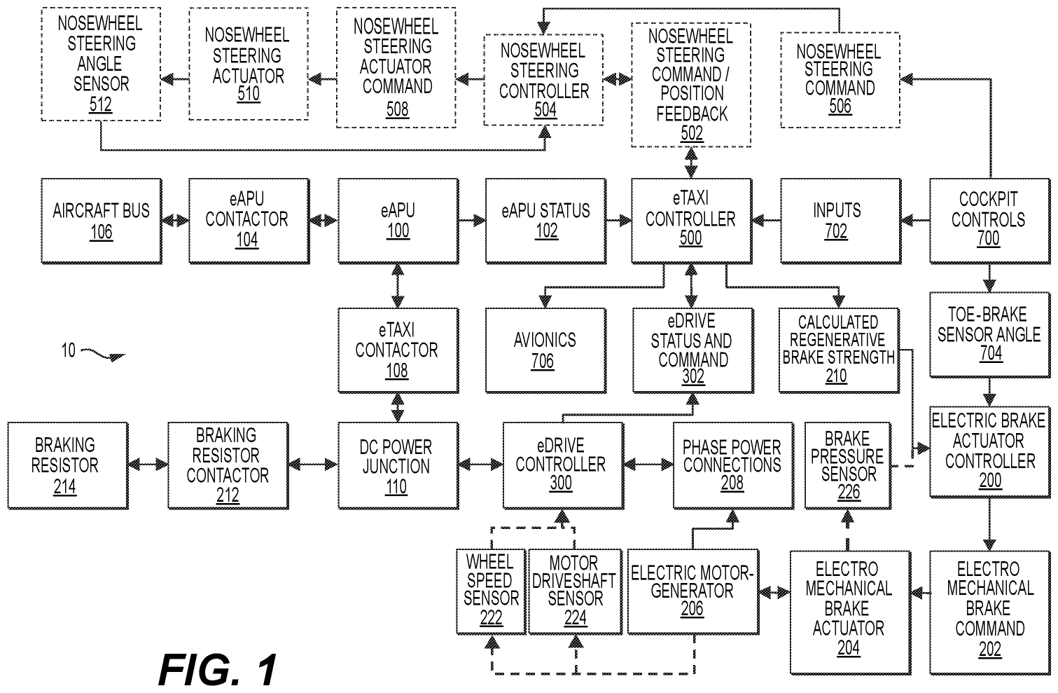

FIG. 1 is a schematic of an exemplary eAPU-based eTaxi system 10 for aircraft. System 10 is an electric aircraft taxi control system, or “eTaxi system” or “eTaxi,” suitable for performing taxi of an aircraft without relying on any engine thrust or power during the taxi process. For instance, an aircraft with dual turbine engines may have these engines offline while the aircraft is taxied with system 10. In embodiments, system 10 may also be used to drive the aircraft landing gear wheels during takeoff and landing using electric power supplied from a battery.

Embodiments herein describe system 10 as it may be employed on aircraft equipped with an electric auxiliary power unit, hereinafter referred to as an “eAPU.” In FIG. 1, an embodiment eAPU 100 comprises a set of high energy-density batteries configured to supply a direct current (hereinafter “DC”) that provide a power source to an aircraft when any engine-driven generators configured on aircraft engines, thrusters, turbines. propellers or other in-flight propulsion mechanisms (not shown) are not running. The use of eAPU 100 allows for purely electric operation of system 10. In an embodiment, eAPU 100 may be installed in place of, or in addition to, a gas turbine APU, or in an aircraft that would otherwise not have a traditional APU installed. An example of an eAPU having battery modules is U.S. Pat. No. 10,864,995 to Chang et al., entitled Hybrid Auxiliary Power Unit for Aircraft, the disclosure of which is hereby incorporated by reference in its entirety.

eAPU 100 is electrically connected to an aircraft bus 106 by means of an eAPU contactor 104. Contactor 104 is for example a relay used to switch on/off high voltage/current lines, and aircraft bus 106 comprises the main electrical system of an aircraft, which possibly includes gas turbine generators and power lines for air conditioning, avionics, and other electric devices typically outfitted on passenger aircraft. eAPU 100 is the power source for the eAPU-based eTaxi system 10 and may also power other components connected to aircraft bus 106. eAPU 100 may be recharged from the main engine generators (not shown) via aircraft bus 106 or from an electric motor-generator 206 during regenerative braking, allowing for a bidirectional power supply between eAPU 100 and aircraft bus 106. In an embodiment, gas turbine generators configured to provide electricity generated by the aircraft engines/thrusters may assist eAPU 100 in driving electric motor-generator 206 during a TO/GA takeoff. In other embodiments, such as with a low-speed taxi procedure, a lesser acceleration, or a light airplane, the TO/GA takeoff may be done relying solely on power from eAPU 100.

A DC power junction 110 is electrically connected to eAPU 100 via an eTaxi contactor 108, wherein eTaxi contactor 108 is a switch configured to be enabled or disabled by a crew member. A braking resistor 214 electrically connects with the DC power junction 110 via a braking resistor contactor 212 such that DC power may be diverted from eAPU 100 to braking resistor 214 via DC power junction 110, for instance when eAPU is in a high state of charge. The braking resistor 214 may provide supplemental braking force during regenerative braking with the diverted DC power.

Cockpit controls 700 provide an interface for the crew to directly control the eTaxi features of system 10. In embodiments, cockpit controls 700 comprise a preexisting set of cockpit input devices such as thrust levers; a yoke, joystick, control wheel, or control column; rudder/tiller; toe brakes; etc. that are configured to provide commands, inputs, or signals from the crew to the eTaxi system 10 when eTaxi system 10 is active In embodiments, cockpit controls 700 may comprise any preexisting aircraft controls or control scheme such that the preexisting aircraft controls may be configured to carry out functions of system 10 while still being configured to provide control for normal aircraft functions. No additional cockpit controls need be introduced to the aircraft to enable a fully functional embodiment system 10 as input signals from existing controls may be received and translated into commands for driving, steering, and braking by system 10. For instance, when a throttle is increased while eTaxi system 10 is active and the aircraft engines are off, the aircraft wheels may be driven forward by power from eAPU 100.

In embodiments, crew inputs are transmitted from cockpit controls 700 to an eTaxi controller 500 via inputs 702 and from cockpit controls 700 to an electric brake actuator controller 200 via a toe-brake angle sensor 704; and in some embodiments, a nosewheel steering command 506 is transmitted from cockpit controls 700 to a nosewheel steering controller 504. As part of cockpit controls 700, the existing throttle levers are used to provide a speed input to the eTaxi system 10 while the engines are off. For example, a throttle position may be determined using one or more sensors, and a signal indicative of the throttle position such as a discrete or continuous electrical signal is provided to eTaxi controller 500. In embodiments, inputs 702 comprise analog signals transmitted from cockpit controls 700. Toe brakes angle sensors 704 mounted to the rudder pedals/toe brakes may be used, along with the eAPU status 102, to determine the availability of regenerative braking and to compute how much, if any, mechanical braking may be required by the aircraft.

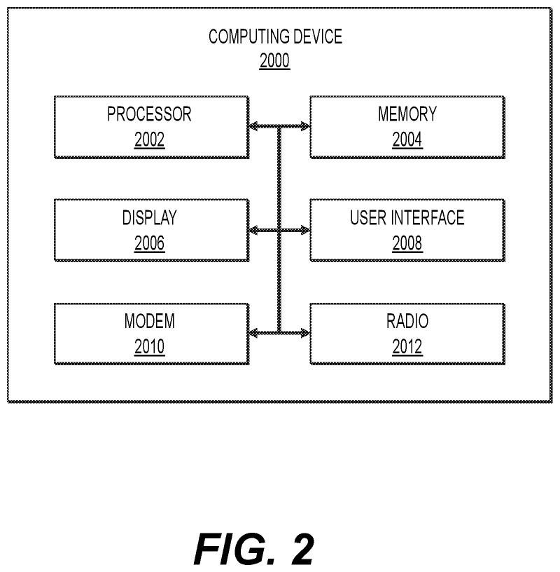

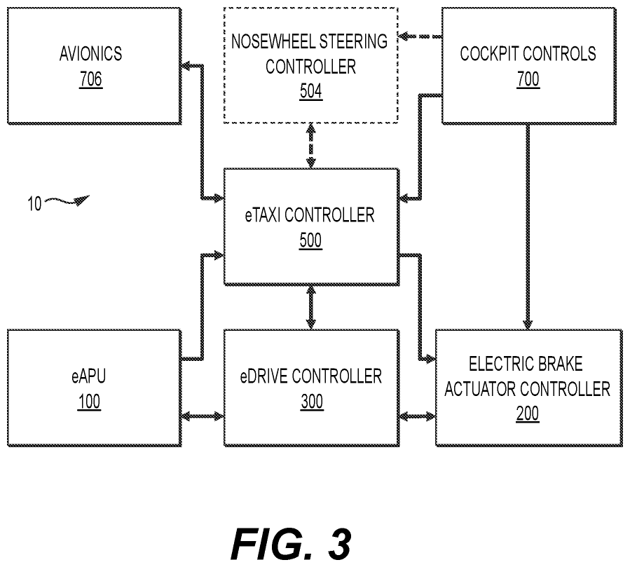

In embodiments, eTaxi controller 500 may compute and transmit outputs from algorithms configured to determine appropriate braking, wheel motor drive, and steering commands for components of system 10 based in part on inputs 702. eTaxi controller 500 may comprise a computer with software installed, wherein the software is configured with algorithms that produce outputs which lead to smooth and predictable eTaxi behavior from system 10. For the purposes of this disclosure, “smooth and predictable behavior” and similar phrases refer generally to a safe, expected, and responsive driving feel that remains consistent according to a current state of an aircraft. The behavior is predictable in the sense that a pilot or crewmember operating the aircraft may use eTaxi features of system 10 intuitively, or that the response of system 10 is similar to that of an aircraft performing a conventional taxi using aircraft thrusters. Steering the aircraft would not be expected to produce a different result between two steering inputs at the same speed with no other factors changed). The details of the control system and computer hardware/software are discussed alongside FIGS. 2 and 3. For steering a differential arc length of the main landing gear wheels during a turn, for example, rudder pedal inputs are provided to eTaxi controller 500, which provides outputs to the wheel motor drive to drive the main landing gear wheels at different speeds through the turn.

An eDrive controller 300 is configured to drive one or more electric motor-generators 206 and to facilitate regenerative braking, and in embodiments eDrive controller 300 may assign each electric motor-generator 206 a “drive mode” and a “regeneration mode” for use when driving an electric motor-generator 206 and performing regenerative braking with an electric motor-generator 206 respectively. One or a plurality of electric motor-generators 206 may be configured on an aircraft, with an electric motor-generators 206 configured to drive each main gear wheel as an electric motor-generator. The function of a single electric motor-generator 206 is referred to for simplicity. Each electric motor-generator 206 may be configured with a wheel speed sensor 222 and a motor driveshaft sensor 224 for determining the speed of a landing gear wheel configured with electric motor-generator 206. Wheel speed sensor 222 comprises a transducer that, when excited, provides a number of pulses per wheel revolution. Motor driveshaft sensor 224 also comprises a transducer configured to determine a driveshaft speed. Feedback from the sensors may be sent to eDrive controller 300 and eTaxi controller 500 for use in control logic and determining drive, steering, and braking commands.

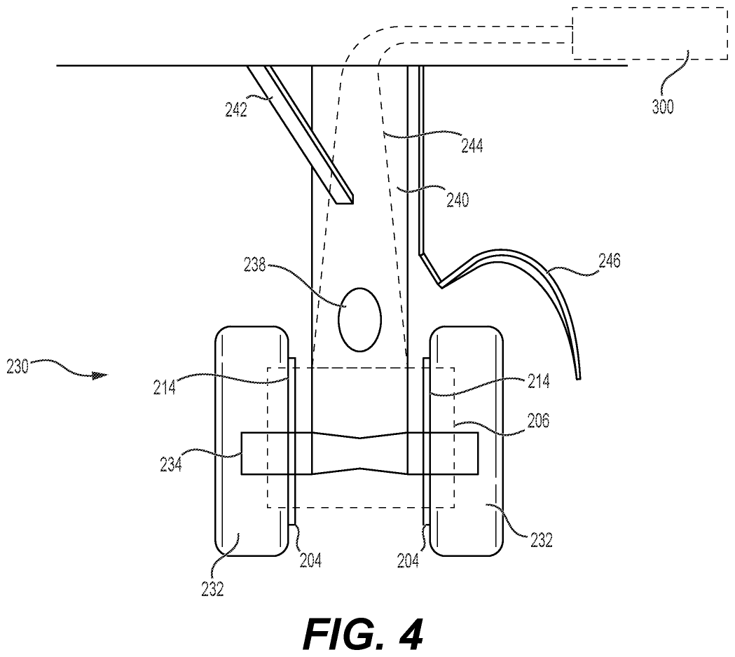

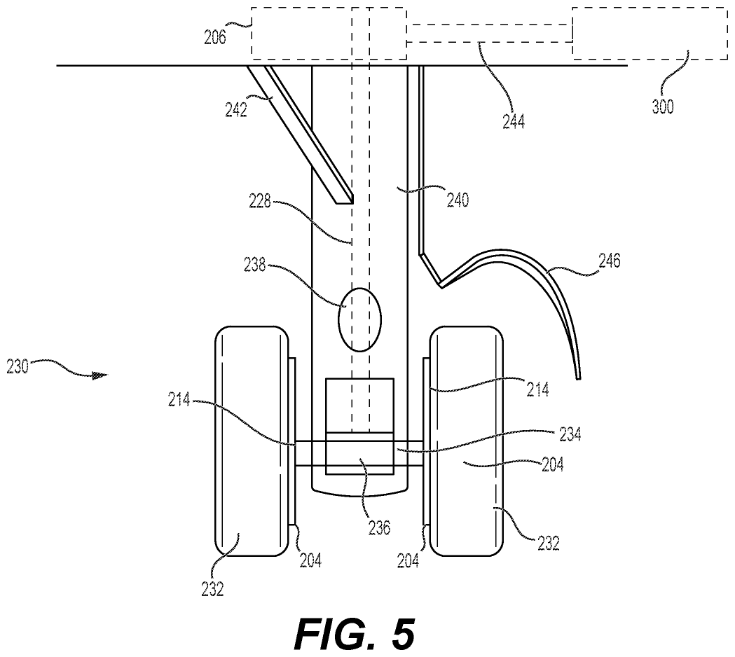

In embodiments such as the embodiment depicted in FIG. 4, electric motor-generators 206 are configured in one or more aircraft landing gear or landing gear wheels, such that each electric motor-generator 206 drives a wheel directly. Electricity from the eAPU is run directly to the landing gear in such embodiments. In other embodiments such as that depicted in FIG. 5, one or more electric motor-generators 206 may drive one or more landing gear wheels via transmission through a driveshaft 228 through the landing gear. Such a configuration may simplify landing gear design by requiring fewer electrical components to be configured on and within the landing gear, and a single driveshaft may be configured to drive multiple landing gear wheels. Additionally, a configuration of electric motor-generators 206 with or without driveshafts may be preferable to adjust weight distribution or simplify construction around the aircraft.

An embodiment eDrive controller 300 may be configured to function as a bidirectional AC/DC converter while also communicating with eTaxi controller 500 and other components. During normal forward taxi (drive mode), eDrive controller 300 functions as an inverter and converts DC power from the eAPU 100 via DC power junction 110 to AC, n-phase, modulated power for the purpose of driving electric motor-generator 206. Electric motor-generator 206 is electrically connected to the eDrive controller 300 by phase power connections 208.

During taxi or TO/GA power configuration, the electric motor-generator 206 may function as a drive motor. During regenerative braking operations (regeneration mode), electric motor-generator 206 functions as a generator and produces n-phase alternating current (hereinafter “AC”) power while the eDrive controller 300 functions as a converter. This n-phase AC power is converted by eDrive controller 300 to DC power which travels along eTaxi contactor 108 to recharge eAPU 100. If more braking force is necessary, or if eAPU 100 is already at a high state of charge, disconnected, or otherwise unavailable, the DC power is instead provided to the braking resistor 214 to provide additional braking.

The eTaxi controller 500 may comprise computer hardware and software that can reside in an independent controller housing, on a printed circuit board in a card cage with other controllers, or integrated onto a separate piece of computer hardware, as later discussed alongside FIGS. 2 and 3. The eTaxi controller 500 and associated subsystem controllers include algorithms stored in non-volatile memory for regenerative braking and eAPU charging; driving electric motor-generators 206 during taxi, TO/GA takeoff; or spinning electric motor-generators 206 to match ground speed prior to landing. During a TO/GA takeoff, traction control may be performed by eTaxi controller 500 to prevent the aircraft tires slipping on the runway surface, wherein a variable level of drive or braking may be applied to each electric motor-generator 206 to maintain predictable behavior of the aircraft.

eTaxi controller 500 operates in conjunction with eDrive controller 300, electric brake actuator controller 200, inputs 702 from cockpit controls 700, and eAPU 100. eTaxi controller 500 sends and receives information from multiple sources. It receives eAPU status 102 information from the eAPU 100, inputs 702 from the cockpit controls 700, sends and receives nosewheel steering command/position feedback 502 from the nosewheel steering controller 504, and sends and receives information from an eDrive status and command 302 to and from eDrive controller 300. eTaxi controller 500 may also send and receive information to and from avionics 706.

Electric brake actuator controller 200 is used to provide braking inputs to an electro-mechanical brake actuator 204. For example, the brake actuator controller 200 may receive inputs from the cockpit controls 700 via a toe-brake angle sensor 704. From this input, the electric brake actuator controller 200 calculates a required electro-mechanical brake command 202 and compares that command to the calculated regenerative brake strength 210 sent from the eTaxi controller 500. Comparing two inputs provides a level of independence and redundancy in calculating the mechanical brake command that may be used to provide for more predictable eTaxi braking behavior. Electric brake actuator controller 200 may also receive inputs from a brake pressure sensor 226 to inform commands sent to electric brake actuator controller 200.

An electro-mechanical brake actuator 204 is a mechanical brake device driven by either an electric actuator or electro-hydraulic actuator as opposed to a purely hydraulic system. The electro-mechanical brake actuator 204 supplements the regenerative braking capability of the system in the case that purely regenerative braking supplied by electric motor-generators 206 is not sufficient to stop the aircraft. There may be one or many electro-mechanical brake actuators 204 installed within each main landing gear.

In certain embodiments, electric nosewheel steering and feedback may be incorporated into the system. In this embodiment, the nosewheel steering controller 504 receives steering commands in the form of a nosewheel steering command 506 from cockpit controls 700 and a digital command from eTaxi controller 500. The commands are compared and converted by nosewheel steering controller 504 to a nosewheel steering actuator command 508, which is then sent to the nosewheel steering actuator 510. Closed-loop feedback is provided by a nosewheel steering angle sensor 512 back to the nosewheel steering controller 504. The nosewheel steering controller 504 is a combination of electronic hardware and software that may reside in an independent controller housing, on a printed circuit board in a card cage with other controllers, or integrated onto a separate piece of electronic hardware.

FIG. 2 shows a block diagram of an example computing device 2000 that facilitates operation of an aircraft configured with an eAPU 100 and components of an embodiment system 10, including components configured to send and receive commands such as eTaxi controller 500 or eDrive controller 300 as described with reference to FIGS. 1 and 3. In some examples, the computing device 2000 is configured to perform functions of system 10 described with reference to FIGS. 1 and 3. The computing device 2000 may include one or more chips, systems on a chip (SoCs), chipsets, packages, components or devices that individually or collectively constitute or comprise a processing system. The processing system may interface with other components of the computing device 2000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the computing device 2000 may transmit the information output from the chip. In such an example, the second interface may refer to an interface between the processing system of the chip and a reception component, such that the computing device 2000 may receive information that is then passed to the processing system. In some such examples, the first interface may obtain information, such as from the transmission component, and the second interface may also output information, such as to the reception component.

The processing system of the computing device 2000 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASICs), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with multiple radios (collectively “the radio”), multiple radio frequency (RF) chains or multiple transceivers, each of which may in turn be coupled with one or more of multiple antennas. In some implementations, one or more processors of the processing system include or implement one or more of the radios, RF chains or transceivers.

In some examples, the computing device 2000 can be configurable or configured for use in an aircraft eTaxi system, such as system 10 comprising eTaxi controller 500 or eDrive controller 300 as described with reference to FIGS. 1 and 3. In some other examples, the computing device 2000 can be a microcontroller that includes such a processing system and other components such as eTaxi controller 500 or eDrive controller 300 with reference to FIGS. 1 and 3.

The computing device 2000 is capable of transmitting and receiving wireless communications in the form of, for example, wireless packets or data elements. For example, the computing device 2000 can be configurable or configured to transmit and receive packets in the form of physical layer PPDUs and MPDUs conforming to one or more of the IEEE 802.11 family of wireless communication protocol standards. In some other examples, the computing device 2000 can be configurable or configured to transmit and receive signals and communications conforming to one or more 3GPP specifications including those for 4G NR or 6G.

In some examples, the computing device 2000 also includes or can be coupled with one or more application processors which may be further coupled with one or more other memories. In some examples, the computing device 2000 further includes at least one external network interface coupled with the processing system that enables communication with a core network or backhaul network that enables the computing device 2000 to gain access to external networks including the Internet.

The computing device 2000 may include a processor component 2002, a memory component 2004, a display component 2006, a user interface component 2008, a modem component 2010, and a radio component 2012. Portions of one or more of the components 2006, 2008, and 2012 may be implemented at least in part in hardware or firmware. In some examples, at least some of the components 2006, 2008, and 2012 of computing device 2000 are implemented at least in part by a processor and as software stored in a memory. For example, portions of one or more of display component 2006, and the user interface component 2008 can be implemented as non-transitory instructions (or “code”) executable by processor 2002 to perform the functions or operations of the respective module.

In some implementations, processor 2002 may be a component of a processing system. A processing system may generally refer to a system or series of machines or components that receives inputs and processes the inputs to produce a set of outputs (which may be passed to other systems or components of, for example, computing device 2000). For example, a processing system of computing device 2000 may refer to a system including the various other components or subcomponents of computing device 2000, such as the processor, or a transceiver, or a communications manager, or other components or combinations of components of computing device 2000. The processing system of computing device 2000 may interface with other components of computing device 2000 and may process information received from other components (such as inputs or signals) or output information to other components. For example, a chip of computing device 2000 may include a processing system, a first interface to output information and a second interface to obtain information. In some implementations, the first interface may refer to an interface between the processing system of the chip and a transmitter, such that computing device 2000 may transmit information output from the chip. In some implementations, the second interface may refer to an interface between the processing system of the chip and a receiver, such that computing device 2000 may obtain information or signal inputs, and the information may be passed to the processing system. A person having ordinary skill in the art will readily recognize that the first interface also may obtain information or signal inputs, and the second interface also may output information or signal outputs.

Processor 2002 is capable of, configured to, or operable to processes information received through radio component 2012, and processes information to be output through radio component 2012 for transmission through the wireless medium. Processor 2002 may perform logical and arithmetic operations using program instructions stored within memory 2004. The instructions in memory 2004 may be executable (by processor 2002, for example) to implement the methods described herein.

Memory 2004 is capable of, configured to, or operable to store and communicate instructions and data to and from processor 2002.

User interface component 2008 may be any device that allows a user to interact with computing device 2000, such as a microphone, dials, buttons, et cetera. In aspects, user interface component 2008 may be integrated with display component 2006 to present aircraft operational information and eTaxi statuses such as with control inputs and flight instruments comprised by cockpit controls 700, with reference to FIGS. 1 and 3.

Modem component 2010 may be any device configured to transmit data from computing device 2000 to another device on a common network such as via the Internet, a local area network, a wide area network, or another suitable network. In embodiments, computing device 2000 may not comprise modem component 2010 and may be interfaced via wired or wireless connection to an external modem for transmission of data on a network.

Radio component 2012 includes at least one radio frequency transmitter and at least one radio frequency receiver, which may be combined into one or more transceivers. The transmitter(s) and receiver(s) may be coupled to one or more antennas. In some aspects, processor 2002, memory 2004, and radio component 2012 may collectively facilitate the wireless communication of computing device 2000 with other wireless communication devices over multiple frequency bands (such as 2.4 GHz, 5 GHZ, or 6 GHz).

The present invention may be a system, a method, and/or a computer program product at any possible technical detail level of integration. The computer program product may include a computer-readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (R.O.M.), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (I.S.A.) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (P.L.A.) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Now referring to FIG. 3, system 10 relies on electric inputs, commands, or signals transmitted between eAPU 100, eTaxi controller 500, eDrive controller 300, electric brake actuator controller 200, cockpit controls 700, and avionics 706, wherein these signals enable communication between these components, and wherein these components may comprise computer hardware similar to computing device 2000 in embodiments with software installed that governs the resulting output of system 10. The output from system 10 is a predetermined response in the sense that an algorithm determines the output in a consistent fashion from the gathered inputs. This leads to predictable taxi behavior when using system 10 such as smooth steering, smooth acceleration with a safe top speed, and more. Generally, inputs from avionics 706, inputs 702, eDrive status and command 302, eAPU status 102, and electric motor-generators 206 may be processed by computer hardware and software of eTaxi controller 500 and eDrive controller 300 to convert crew inputs sourced from cockpit controls 700 into smooth, predictable, and safe aircraft taxi behavior.

eTaxi controller 500 is configured to receive inputs directly from eAPU 100, eDrive controller 300, nosewheel steering controller 504, cockpit controls 700, and avionics 706, in embodiments, and is configured to send outputs, commands, or signals to electric brake actuator controller 200, eDrive controller 300, nosewheel steering controller 504, and avionics 706. In embodiments where eTaxi controller 500 comprises a computing device 2000, software installed in a memory component 2004 may be configured to process inputs from any of the aforementioned input components into output commands configured to create smooth, predictable, and safe aircraft taxi behavior.

In embodiments, eDrive controller 300 is configured to receive inputs directly from eAPU 100, eDrive controller 300, and electric brake actuator controller 200, and is configured to send outputs, commands, or signals to eAPU 100, eDrive controller 300, and electric brake actuator controller 200. In embodiments where eDrive controller 300 comprises a computing device 2000, software installed in a memory component 2004 may be configured to process inputs from any of the aforementioned input components into output commands configured to create smooth, predictable, and safe aircraft taxi behavior.

System 10 may be configured to be enabled or disabled via a crew input to cockpit controls 700, such that system 10 and taxi functionalities are not executed during flight when aircraft landing gear are not deployed. A user interface display such as a monitor configured in cockpit controls 700 may provide system information to crew about the status of the eTaxi system, such as eAPU status 102 or data gathered by avionics 706. Moreover, crew may be able to interact with the user interface or another set of controls to adjust regenerative braking strength, calibrate auto-braking for exiting a runway at a preselected taxiway, or otherwise adjust the behavior of system 10 to provide for more predictable taxiing behavior or to provide for a preferred taxi feel, such as by increasing the gain on nosewheel steering controller 504 for a more responsive steering feel.

The operation of the eTaxi system may be broken into four sub-groups: sourcing power, providing steering control, providing taxi drive, and providing braking. eAPU 100 powers the system from battery charge or from power available from aircraft bus 106, and system 10 is powered when eTaxi contactor 108 is engaged. Electrical power may also be sourced from any of electric motor-generators 206 during regenerative braking, and electrical power from eAPU 100 may be used for electric propulsion, electric steering, or electric braking of an aircraft.

To provide steering control, system 10 may employ nosewheel steering, traditional hydraulic steering, or differential driving/braking. In embodiments of the system where the nosewheel steering actuator 510, the nosewheel steering angle sensor 512, and the nosewheel steering controller 504 are installed, directional control during aircraft taxi is provided by system 10. Cockpit controls 700 provides crew inputs to system 10, and the crew inputs along with other inputs are processed by software installed on eTaxi controller 500 and eDrive controller 300 to provide stable, predictable steering. For instance, the aircraft's current taxi speed (sourced from avionics 706 or at least one wheel speed sensor 222) is a control input to the nosewheel steering controller 504. Using taxi speed data, the gain of the nosewheel steering may be increased at very low speeds and decreased at normal taxi speeds. This allows the aircraft to turn in a much tighter radius at low speed (i.e., on a ramp), but provide stable directional control at higher taxi speeds.

In embodiments of the system lacking active nosewheel steering (such as with free castering nosewheels) or comprising traditional hydraulic steering, the eTaxi controller 500 may be configured to provide differential braking commands to the two sides of the aircraft via the electric brake actuator controller 200 and differential drive commands to eDrive controller 300. Crew inputs from cockpit controls 700 provide steering commands, and the resultant output to electric motor-generators 206 and electric brake actuator controller 200 may be modified by system 10 to mimic traditional steering controls. By providing differential drive and braking commands to the two sides of the aircraft, embodiments of the system may drive one wheel forward and the other backwards, allowing the aircraft to turn within its own radius.

To provide taxi drive, eTaxi controller 500 and eDrive controller 300 process signals from one another and from eAPU 100, electric motor-generators 206, and cockpit controls 700 into output signals that lead to smooth and predictable forward or reverse taxi motion for an aircraft. When eTaxi controller 500 receives crew input from cockpit controls 700 (such as a non-zero level of throttle) and an acceptable eAPU status 102 of the eAPU 100. eTaxi controller 500 sends a command proportional to its received input to the eDrive controller 300. eDrive controller 300 then functions as an inverter to convert DC power from the eAPU into n-phase AC power for driving the electric motor-generators 206.

While taxiing, the maximum power provided to the electric motor-generators 206 is limited to a percentage of the maximum discharge rate of the eAPU 100. This limitation prevents the aircraft from exceeding a safe forward taxi speed and becoming difficult to control. In embodiments, wheel speed sensors 222 and motor drive shaft sensors 224 may be configured to provide closed-loop feedback to eDrive controller 300. Closed-loop feedback allows eDrive controller 300 to monitor the speed of the motor and adjust its output to closely match the real speed of the aircraft to a commanded taxi speed (for instance, a current taxi speed of 20 knots indicated to a crew member on a display of cockpit controls 700), thereby providing for predictable operation of the aircraft during eTaxi.

In embodiments where TO/GA input is provided from the cockpit controls 700 to eTaxi controller 500, eDrive controller 300 may apply a maximum power to electric motor-generators 206 to provide a maximum thrust from the landing gear wheels during takeoff to reduce the runway distance required for takeoff. When performing a reduced-distance takeoff, eDrive controller 300 will first drive electric motor-generators 206 at maximum torque. As the aircraft accelerates, eDrive controller 300 will begin reducing the torque demand from electric motor-generators 206 such that the torque delivered by the motors is approximately zero by the time the aircraft has reached rotation speed. This driving behavior during takeoff is configured to gently reduce aircraft acceleration from the wheels, preventing an abrupt and unexpected drop in acceleration during rotation while maintaining smooth and predictable behavior even during takeoff. During this initial acceleration, eDrive controller 300 may enact traction control based on feedback from wheel speed sensors 222 and motor drive shaft sensors 224, wherein power to a given electric motor-generator 206 is reduced if wheelspin occurs to prevent inefficiency from wheelspin and to keep the aircraft moving forward in a controlled direction during takeoff.

In embodiments, during aircraft landing, airspeed or groundspeed data from avionics 706 may be input to eTaxi controller 500 and eDrive controller 300 and output as a command to drive electric motor-generators 206, possibly to a maximum thrust. Electric motor-generators 206 may accelerate main gear wheels or other driven aircraft wheels until the wheel speed corresponds to the ground speed, thereby reducing tire wear upon touchdown.

In embodiments, when the eTaxi system is configured to allow electric motor-generators 206 to coast when no power is applied, the brake pedals must be engaged to slow the aircraft. As given by crew inputs to cockpit controls 700, the angle of the toe brakes may correspond to the amount of braking action output to electric brake actuator controller 200, braking resistor 214, electric motor-generator 206, or mechanical brakes disposed on the aircraft. The eTaxi controller 500 takes in inputs such as the level of charge of eAPU 100 and the temperature of braking resistor 214 to calculate how much regenerative braking is possible. This information is transmitted to electric brake actuator controller 200. If additional mechanical braking is required, electric brake actuator controller 200 sends a command to electro-mechanical brake actuator 204 to supplement the regenerative braking with traditional mechanical braking.

Electro-mechanical brake actuator 204 mitigates the need for a large hydraulic brake system, and in embodiments system 10 may engage electro-mechanical brake actuator 204 to provide a clamping force to a mechanical brake when regenerative braking from electric motor-generator 206 is insufficient. In another embodiment, electro-mechanical brake actuator 204 is electro-hydraulic and comprises a small electric pump configured to create hydraulic pressure locally with a small amount of hydraulic fluid. At the same time, eDrive controller 300 sends a command to electric motor-generator 206 to perform regenerative braking and recharge eAPU 100. If the eAPU 100 has a high state of charge, or is otherwise not able to accept the energy supplied from eDrive controller 300, braking resistor 214 may be engaged to convert electrical energy to heat, thereby providing additional braking from the recovered energy on top of the regenerative braking performed by electric motor-generator 206 and, in embodiments, on top of the mechanical braking performed by electro-mechanical brake actuator 204. In embodiments, eDrive controller 300 may optimize braking efficiency by calculating the total braking strength needed, supplying as much braking strength as possible using electric motor-generator 206 and braking resistor 214, and supplementing this braking with any additional braking strength required to reduce the speed of the aircraft to a safe speed.

System 10 may also be used for autonomous braking. allowing the aircraft to reduce speed autonomously during roll-out after landing so as to exit the runway at a pre-selected taxiway. eDrive controller 300 may process data from avionics 706, such as a calculated ground speed of the aircraft at the touchdown point, the landing configuration of the aircraft (e.g., flaps, spoilers, thrust reverse), and the condition of the runway surface, to calculate the amount of braking force necessary for constant deceleration to arrive at a preselected taxiway at a safe runway exit speed. Said braking force may then be automatically applied via instructions issued by eDrive controller 300 to the aircraft to perform regenerative braking with electric motor-generators 206, braking resistor 214, or electromechanical brake actuator 204.

Referring now to FIG. 4, a landing gear 230 comprises wheels 232, an axle 234 a differential 236, a light 238, a landing gear shock strut 240, a side strut 242, and undercarriage doors 246. A new or a preexisting landing gear 230 may be configured with an electric motor-generator 206 connected directly to axle 234 to drive wheels 232 or perform regenerative braking via wheels 232. Brakes on the aircraft may comprise or be mechanically and/or electrically coupled to electromechanical brake actuator 204, braking resistor 214, and other methods for stopping an aircraft including purely mechanical brakes may be disposed directly on wheels 232 or axle 234. In embodiments, braking resistor 214 may be mounted with the control electronics to assist with regenerative braking formed by electric motor-generator 206.

An embodiment eDrive controller 300 is configured within the main body of an aircraft and may communicate and supply power to all electric motor-generators 206 configured on an aircraft with system 10. A conduit 244 electrically connects electric motor-generator 206 and eDrive controller 300 to power and send commands to electric motor-generator 206. Electric motor-generator 206 may also comprise or be configured with a differential 236, a gearbox and clutch assembly, or other powertrain equipment.

Referring now to FIG. 5, an aircraft may be configured with an electric motor-generator 206 connected to axle 234 or wheels 232 via a driveshaft 228. Driveshaft 228 runs through or may run parallel to landing gear 230, and in a specific embodiment within shock strut 240, such that an electric motor-generator 206 may be mounted on the main body of the aircraft instead of landing gear 230 and still transmit power or perform regenerative braking with wheels 232. In this case, differential 236 and other powertrain equipment may be configured at an end of driveshaft 228 opposite of electric motor-generator 206. Otherwise, the assembly of landing gear 230 may be substantially similar to the embodiment shown in FIG. 4.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

The invention claimed is:

1. An eAPU-based aircraft taxi control system, comprising:
an electric auxiliary power unit configured to provide electrical power;
a drive controller configured to control a main gear electric motor-generator;
an electric brake actuator controller configured for providing braking; and
a taxi controller operatively coupled to the electric auxiliary power unit, the drive controller, the electric brake actuator controller and preexisting aircraft controls, wherein the taxi controller is configured to provide steering and drive control for taxiing the aircraft based on inputs received from the preexisting aircraft controls without receiving power from an aircraft engine.

2. The system of claim 1, wherein the taxi controller is configured to process inputs from at least the drive controller and the preexisting aircraft controls into commands sent to the drive controller, wherein the commands are configured to produce smooth and predictable driving behavior based on the inputs.

3. The system of claim 1, wherein the taxi controller is integrated with an aircraft throttle in the preexisting aircraft controls to provide drive control during aircraft taxi.

4. The system of claim 1, wherein the taxi controller is integrated with a set of aircraft toe brakes in the preexisting aircraft controls to provide braking control during aircraft taxi.

5. The system of claim 1, wherein the taxi controller is integrated with a yoke in the preexisting aircraft controls to provide steering control during aircraft taxi.

6. The system of claim 1, wherein the electric auxiliary power unit is connected to an aircraft electrical bus such that power may travel bidirectionally between the electric auxiliary power unit and the aircraft electrical bus.

7. The system of claim 1, comprising a nosewheel steering controller integrated into the taxi controller wherein commands from the taxi controller sent to the nosewheel steering controller steer an aircraft nosewheel via a nosewheel steering actuator.

8. The system of claim 1, wherein the taxi controller allows for the configuration of regenerative braking strength, auto-braking, and driving response behavior.

9. An aircraft taxi system comprising:
an electric power source configured to supply stored power installed on an aircraft configured to power aircraft and taxi system components;
a plurality of main gear wheels each comprising:
an electric motor-generator configured to drive a main gear wheel when powered by the electric power source and configured to provide regenerative braking;
an electro-mechanical brake configured to provide a braking force on the main gear wheel; and
a brake resistor configured to provide regenerative braking by converting electricity into heat; and
a taxi controller configured to control the plurality of main gear wheels for performing forward and reverse driving, braking, and steering.

10. The system of claim 9, comprising a set of preexisting cockpit controls configured to provide inputs to the taxi control system, wherein the inputs are processed into commands sent to the drive control system.

11. The system of claim 9, wherein the power source comprises an electric auxiliary power unit independent of a turbine auxiliary power unit.

12. The system of claim 11, wherein the electric auxiliary power unit is recharged by generators on an aircraft engine when the aircraft engine is on.

13. The system of claim 9, wherein the electric motor-generators recharge the electric power source when performing regenerative braking.

14. The system of claim 13, wherein the electric motor-generators supply power to the brake resistors instead of recharging the electric power source to provide supplemental braking.

15. The system of claim 9, wherein the electric motor-generators drive the main gear wheels at a maximum thrust during takeoff and wherein the electric motor-generators drive the main gear wheels during landing to match a speed of the main gear wheels to a ground speed of the aircraft.

16. A method for electric aircraft taxiing, comprising:
providing electric power from an auxiliary power source configured onboard an aircraft, wherein the auxiliary power source provides electric power independent of aircraft engine power; and
integrating a taxi controller with preexisting cockpit controls such that the cockpit controls are configured to control the aircraft via the taxi controller for performing the electric taxiing steps of;
driving at least one main landing gear wheel powered by the electric power source for driving the aircraft;
steering a nosewheel for steering the aircraft; and
braking the at least one main landing gear wheel for braking the aircraft.

17. The method of claim 16, comprising driving the main landing gear wheel during takeoff while the aircraft engines are on.

18. The method of claim 16, comprising driving the main landing gear wheel during landing such that a speed of the main landing gear wheel matches a ground speed of the aircraft.

19. The method of claim 16, comprising performing regenerative braking on the main landing gear wheel and recharging the electric power source while performing regenerative braking.

20. The method of claim 19, comprising diverting power sourced from regenerative braking to a brake resistor configured to provide supplemental braking.
